(19) United States
(12) Patent Application Publication
(10) Pub. No.: US 2011/0108473 A1
(43) Pub. Date: May 12, 2011

(54) MICROMECHANICAL FILTER FOR MICROPARTICLES, IN PARTICULAR FOR PATHOGENIC BACTERIA AND VIRUSES, AND ALSO PROCESS FOR PRODUCTION THEREOF

(76) Inventors: Alois Friedberger, Glonn (DE); Gerhard Mueller, Grafing (DE)

(21) Appl. No.: 12/303,675

(22) PCT Filed: Jun. 1, 2007
(86) PCT No.: PCT/DE07/00987

§ 371 Date: Dec. 5, 2008

(30) Foreign Application Priority Data
Jun. 6, 2006 (DE) 10 2006 026 559.9

(51) Int. Cl. B01D 71/02; B01D 65/02; B01D 69/12; B01D 67/00

(52) U.S. Cl. 210/184; 210/407; 210/409; 29/592; 216/47

(57) ABSTRACT

A micromechanical filter for microparticles is suitable in particular for filtering pathogenic bacteria and viruses, and comprises a substrate and a perforated membrane permanently connected to the substrate, for filtering out microparticles from a medium while flowing through the membrane, and furthermore a device for removing the filtered-out microparticles from the surface of the membrane. The device for removing the microparticles is embodied, for example, as a heating device, in order to burn the microparticles located on the surface of the membrane. It can also be embodied as an actuator structure for deforming the membrane or as a microinjector for generating a flow parallel to the surface of the membrane.

### BACKGROUND OF THE INVENTION

1. Field of the Invention

The invention relates to a micromechanical filter for microparticles, in particular for pathogenic bacteria and viruses, with a substrate and a perforated membrane permanently connected to the substrate, for filtering out microparticles from a medium while flowing through the membrane, as well as a method for producing a micromechanical filter.

2. Background Information

Micromechanical filters for microparticles, such as, for example, pathogenic bacteria, other germs, viruses, etc., can be used in particular in the area of drinking water supply in order to protect drinking water networks from contamination. The supply networks must thereby be protected on the one hand from penetration by undesirable particles, on the other hand it is necessary to detect existing particles and if necessary to determine their degree of contamination or a number of germs or bacteria or also viruses. Pathogens, such as for example, pathogenic germs, bacteria, and viruses must also be reliably detected in the air. In particular the detection of biological agents in liquids and gases is also important thereby.

Printed publication DE 101 34 860 A1 describes a device and a method for detecting immunogenic particles with a filter part for retaining the immunogenic particles and a sensor element to receive a signal generated by immunogenic particles located in the filter material.

U.S. Pat. No. 5,258,285 shows a method for detecting a concentration of bacteria in a sample in which cell populations are concentrated on the surface of a moveable filter material. For the measurement, the filter material containing the concentrated bacteria cells is moved to an extraction chamber.

Printed publication EP 0 612 850 B1 describes a method for determining the number of microorganisms in a sample solution, in which the sample solution is filtered through a filtration membrane in order to entrap microbes thereon. The microbe-containing membrane is sprayed with a solution of an ATP extracting reagent and subsequently with a solution of a luminescence-inducing reagent in order to subsequently determine the degree of luminescence.

In the known detection and filtering methods there is a need to increase the enrichment of bacteria in order to improve the detection limit. Furthermore, it should be possible to reuse the filters used as often as possible. A higher sensitivity should be achieved in the field of detection methods. Above all, conventional filters embodied as volume filters have the disadvantage of rapid soiling, and the microfilters hitherto known in many cases show a limited mechanical stability.

### SUMMARY OF THE INVENTION

The present invention provides for a filter for microparticles and, in particular, for bacteria and viruses, which effectively enriches microparticles and renders possible an improved detection with a higher sensitivity with a longer service life of the filter.

This object is attained through the micromechanical filter for microparticles, in particular for pathogenic bacteria and viruses, with a substrate and a perforated membrane permanently connected to the substrate, for filtering out microparticles from a medium while flowing through the membrane, and through the method for producing a micromechanical filter.

Further advantageous features, aspects and details of the invention are further disclosed in the specification and the drawings of this disclosure.

The micromechanical filter for microparticles according to the invention is suitable in particular for filtering pathogenic bacteria and viruses and comprises a substrate and a perforated membrane permanently connected to the substrate for filtering out microparticles from a medium while flowing through the membrane, and furthermore a device for removing the filtered-out microparticles from the surface of the membrane.

The micromechanical filter according to the invention has an increased service life and a high mechanical stability. Furthermore, it can be reused and also renders possible in particular a detection of bacteria and other germs or also viruses with high sensitivity. The micromechanical filter is used not only to filter out and enrich germs or microparticles that are present in water or other liquids, but also to filter out and enrich microparticles and germs that are present in the air or in a gas. Pathogens or biological warfare agents can be detected therewith for example.

Advantageously, the device for removing the microparticles comprises a heating device for heating the membrane in order to burn the microparticles located on the surface of the membrane.

It is thus possible to clean the microfilter by burning off, wherein the membrane can be heated for example by a current flow to the extent that all combustible materials that have collected on the surface of the membrane are removed. The membrane can thereby be heated, for example, to 700° C. and more, to approx. 1,000° C. according to a particular embodiment, and to approx. 1,200° C. in another particular embodiment. A membrane that is produced from silicon carbide or SiC is particularly suitable thereby.

The heating device is formed, for example, by electrical contacts that are embodied such that upon application of a power source, a heat current flows through the membrane. This has the particular advantage of a low structural expenditure, wherein apart from the contacts no additional components are needed.

However, it is also advantageous to form the heating device by a serpentine heating element that is thermally coupled to the membrane.

Through the heating device it is also possible to disinfect or sterilize the membrane such that the filter can be reused and numerous consecutive measurements can be carried out.

The device for removing the microparticles comprises, in a particular embodiment, an actuator structure that is attached to the membrane, in order to deform the membrane.

Through the attachment of actuator structures, which are, for example, FPW structures (flexural plate wave), onto the chip surface or membrane surface, during operation an agitation can be generated on the surface of the membrane embodied with micropores, through which agitation existing particles or germs are detached or also transported away from the filter surface. This means that the actuator or FPW structure generates waves in the membrane that effect a removal of the soiling or the particles present. On the other hand, biochemical processes can also be accelerated on the surface of the filter through the agitation of the membrane.

According to a particular embodiment of the invention, the actuator structure is embodied such that it generates wave motions in the membrane, such as in the form of surface waves according to a particular embodiment.

Advantageously, the device for removing the microparticles comprises a micropump and/or a microinjector, which generates a flow parallel to the surface of the membrane, which flow detaches the bacteria or particles from the membrane. The germs or microparticles can thereby be removed from the microfilter and transported further, for example to a detection unit.

The surface of the microfilter thereby provides the special advantage that, e.g., bacteria after enrichment can be removed from the surface of the microfilter again very easily. In the case of normal filters or volume filters only approx. 50% can be removed again. According to a particular embodiment, the micromechanical filter is installed in a microfluid system.

Advantageously, the micromechanical filter comprises a device for amplifying bacteria that have been removed from the surface of the membrane. The device can be, e.g., a microreactor or the like, which is embodied for carrying out a polymerase chain reaction or PCR, e.g., carries out an amplification of the DNA. The precision and sensitivity of the measurement is considerably increased thereby.

According to a particular embodiment, the device comprises a detector unit for detecting the germs removed from the surface of the membrane and/or amplified. The type of bacteria, for example, can be determined thereby, and spores, viruses and other microparticles can be detected. In particular in combination with an amplification of bacteria, a particularly large measuring accuracy results in the detection.

According to a particular embodiment, the membrane is formed from monocrystalline silicon, wherein the substrate is also formed from monocrystalline silicon. This results in a particularly high mechanical stability, in particular because not only the carrier of the membrane, i.e., the substrate, but also the membrane material itself is formed from monocrystalline silicon.

Advantageously, the membrane and/or the substrate is formed from silicon carbide. This results in an even higher mechanical stability and a higher chemical and thermal stability. The silicon carbide can thereby be embodied in a monocrystalline or polycrystalline manner.

Advantageously, the micromechanical filter is produced from a metal that has an oxidation-resistant coating. A high mechanical stability with a high chemical and thermal stability is also achieved through this measure.

According to another aspect of the invention, a method for producing a micromechanical filter is disclosed, in which a part of a substrate is porosified in order to form a layer provided with holes, and another part of the substrate is removed, so that a membrane is formed from the substrate, wherein the membrane is formed from the layer provided with holes, and furthermore a device is embodied for removing deposits from a surface of the membrane.

According to a particular embodiment, first the porosification of the substrate is carried out from the surface thereof up to a defined depth, and subsequently the other part of the substrate is removed at least in part from the underside thereof, so that the porous layer forms a membrane with through holes.

Alternatively thereto, the substrate comprises a lower substrate layer with an SOI (silicon on insulator) wafer arranged above it, wherein a part of the lower substrate layer is removed by etching and wherein the insulating layer of the SOI wafer is used as an etching stop.

Advantageously, after the etching of the lower substrate layer, the insulation layer of the SOI wafer is removed, and subsequently the silicon layer of the SOI wafer is porosified, in order to form the membrane provided with through holes.

Advantageously, a micromechanical filter according to the invention is produced with the method according to the invention.

### BRIEF DESCRIPTION OF THE DRAWINGS

The invention is described below by way of example based on the drawings, in which

FIG. 1 shows a micromechanical filter with a heating device for removing microparticles according to a first embodiment as plan view and as sectional view;

FIG. 2 shows a membrane with a serpentine heating element as a heating device for a micromechanical filter according to a second embodiment diagrammatically as a plan view;

FIG. 3 shows diagrammatically a micromechanical filter with a microinjector for removing microparticles according to a third embodiment of the invention;

FIG. 4 shows diagrammatically a micromechanical filter with an actuator structure for removing particles according to a fourth embodiment as a plan view;

FIGS. 5a and 5b show a substrate for producing a micromechanical filter according to the invention in two different stages of production; and

FIGS. 6a-c show diagrammatically a substrate for producing a micromechanical filter in three different production stages according to another production method.

### DETAILED DESCRIPTION OF THE INVENTION

Advantages and features that are described in connection with the micromechanical filter also apply to the method according to the invention and vice versa. Elements with essentially the same properties or functions are labeled with the same reference numbers in the figures.

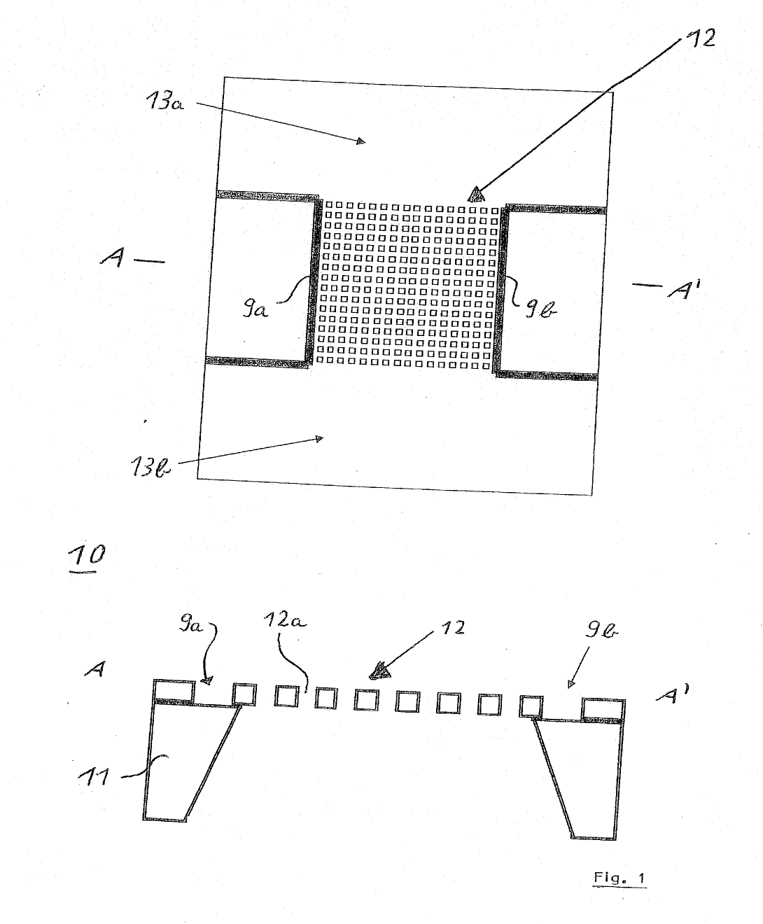

FIG. 1 shows a micromechanical filter 10 as a first embodiment of the invention in a plan view and as a sectional view along the line A-A′. The micromechanical filter 10 has in its lower area a structured substrate 11 that bears a perforated membrane 12. The membrane 12 is provided with through holes 12a and serves to filter out microparticles from a medium while flowing through the membrane 12. A first contact surface 13a and a second contact surface 13b for the electrical connection of a power supply are located on the top of the membrane 12. The power supply provides an electric current between the contact surfaces 13a and 13b through the perforated membrane 12 so that this is heated based on the current flow. At a heating temperature of, e.g., 700° C. to 1,000° C., a combustion occurs of the filtered-out microparticles that are located on the surface of the membrane 12. That means that the two contact surfaces 13a, 13b form a device for removing the filtered-out microparticles from the surface of the membrane 12.

The perforated membrane 12 is structured along the two lines 9a, 9b such that the current flow there is interrupted and the electric current flows over the perforated membrane 12 when it is contacted on the contact surfaces 13a, 13b.

The substrate 11 comprises monocrystalline silicon. In order to achieve a higher mechanical stability, the membrane 12 provided with micropores also comprises monocrystalline silicon. However, it is also possible to use other materials, for example silicon nitrite (Si₃N₄) as a membrane material. In cases where a particularly high mechanical stability and a particularly high chemical and thermal stability are necessary, in particular silicon carbide (SiC) is suitable as a material for the membrane 12 and, in a particular embodiment, also as a material for the substrate 11, which serves as carrier for the membrane 12. Monocrystalline as well as a polycrystalline SiC can be used thereby.

Depending on the area of application and field of use of the micromechanical filter 10, for example, an oxidation-resistantly coated metal is also suitable as a material for the filter 12 or microfilter.

In the illustrated exemplary embodiment, the through holes 12a of the membrane 12 or pores have a diameter of 450 nm. Depending on the area of application, however, they can also have different diameters that are suitable for retaining microparticles in the form of bacteria, viruses, germs, etc. at the surface of the membrane 12, when a liquid or gaseous medium flows through the membrane 12 through the holes 12a.

FIG. 2 shows an alternatively embodied membrane 22 as a plan view, according to a second embodiment of the invention. A serpentine heating element 23, that is applied to the membrane 22 and has on both of its ends respectively a contact surface 23a, 23b for the electrical connection of a voltage supply, is located in the area of the through holes 12a of the membrane 22 thereby. As with the first embodiment shown in FIG. 1, in this case residues or microparticles that are located on the surface of the membrane 22 are also removed thermally or by heating the membrane 22, i.e., the residues or microparticles are burnt.

The other elements and features of the embodiment shown in FIG. 2 are as described above with reference to FIG. 1.

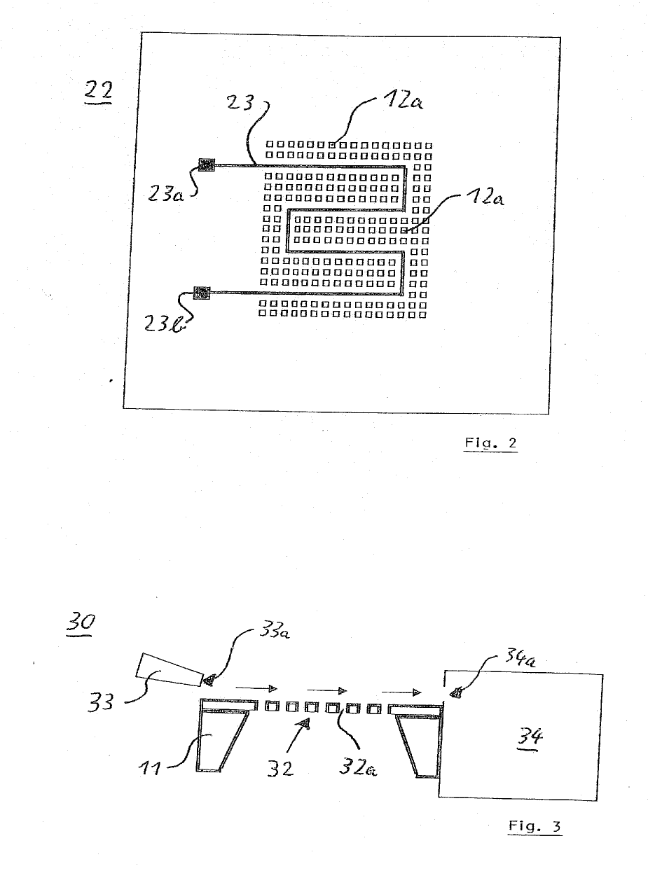

FIG. 3 shows a micromechanical filter 30 according to a third embodiment of the invention. The micromechanical filter 30 has a structured substrate 11 embodied as a carrier, on which substrate a perforated membrane 32 is supported which is provided with through holes 32a. The membrane 32 is permanently connected to the substrate 11 lying beneath. At the side of the membrane 32 a microinjector 33 is provided, which generates a liquid flow or a gas flow along the surface of the membrane 32 or parallel thereto, in order to remove microparticles located there which are deposited as residues on the membrane 32 after the filter process. To this end, an opening 33a of the microinjector 33 is embodied as a nozzle that is directed onto the surface of the membrane 32 in the area of the through holes 32a. The microinjector 33 comprises a micropump, in order to pump a liquid or gaseous medium for rinsing the membrane surface through the nozzle-shaped opening 33a.

A microreactor 34 with a detection device is provided on the side of the membrane 32 lying opposite the microinjector 33. The microreactor 34 comprises an inlet opening 34a that serves to receive the microparticles filtered out and removed from the surface of the membrane 32 in the microreactor 34. This means that germs on the membrane surface after enrichment are removed by the microfluid system shown from the microfilter and transported further, for example to a detection unit and/or into a microreactor or the like. In the case shown here a PCR (polymerase chain reaction) occurs in the microreactor 34, i.e., an amplification of the DNA. The type of bacteria can be determined thereby, for example. However, the detection is also suitable for spores, viruses, etc.

The features and properties of the substrate 11 and of the membrane 32a essentially correspond to the features discussed above with reference to FIGS. 1 and 2, wherein, however, a microinjector instead of a heating device is provided to remove the microparticles.

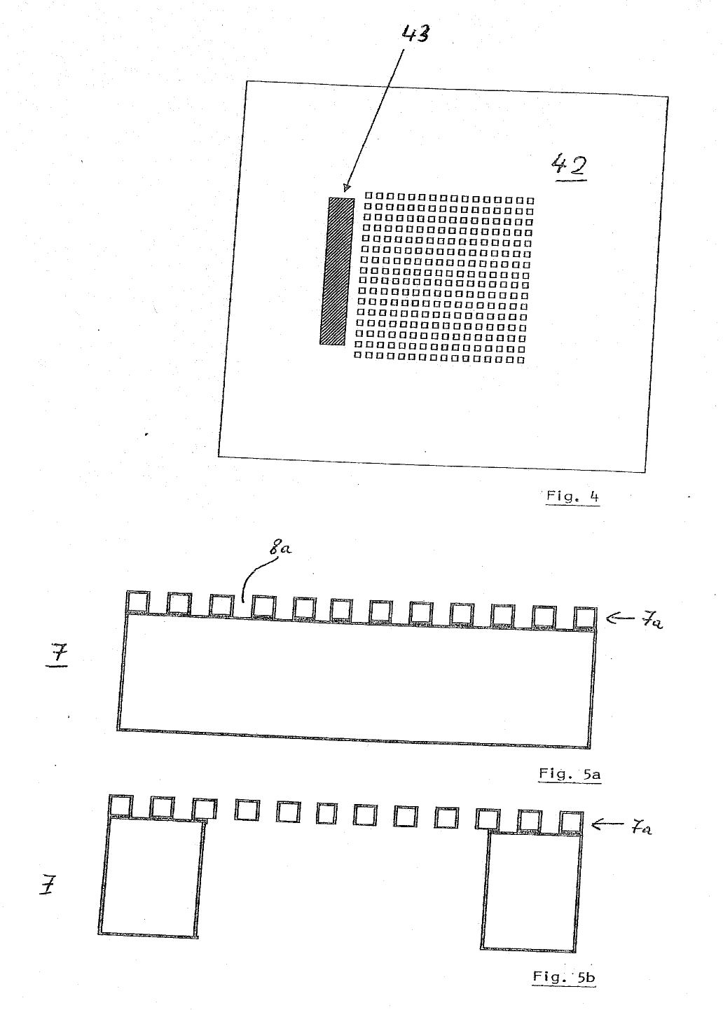

FIG. 4 shows a membrane 42 of a filter according to a fourth embodiment of the invention. An actuator structure 43 for exciting surface waves in the area of the perforated membrane 42 is thereby arranged on the membrane 42. The substrate lying beneath is embodied as in the other embodiments already discussed.

The actuator structure 43 comprises, for example, one or more FPW structures (flexural plate wave) that are arranged on a chip surface or membrane surface in order to generate an agitation on the surface thereof. This agitation serves to accelerate biochemical processes on the membrane surface and/or the transportation away from the filter surface of the microparticles or germs that are deposited as residues on the filter surface.

A method for producing the micromechanical filter is described below based on FIGS. 5a and 5b.

First a prepared substrate 7, which is made, e.g., of silicon, is porosified starting from the surface thereof, so that it is pervaded by thin channels or holes 8a (FIG. 5a). The porosity or thickness of the layer 7a of the substrate 7, which layer is provided with channels or holes 8a, is determined thereby by the doping of the substrate, as well as by the current density and composition of the electrolytes used. The process can thereby also be further adjusted, for example, by electrochemical etching with light irradiation. As soon as the desired membrane thickness corresponding to the thickness of the layer 7a has been reached, the process of porosification is completed.

In a central area of the later membrane or the perforated layer 7a, the substrate lying beneath the porosified layer 7a is removed from below (FIG. 5b). The removal of the substrate area takes place, for example, by conventional dry etching. The individual process steps described here can also be carried out in a different order.

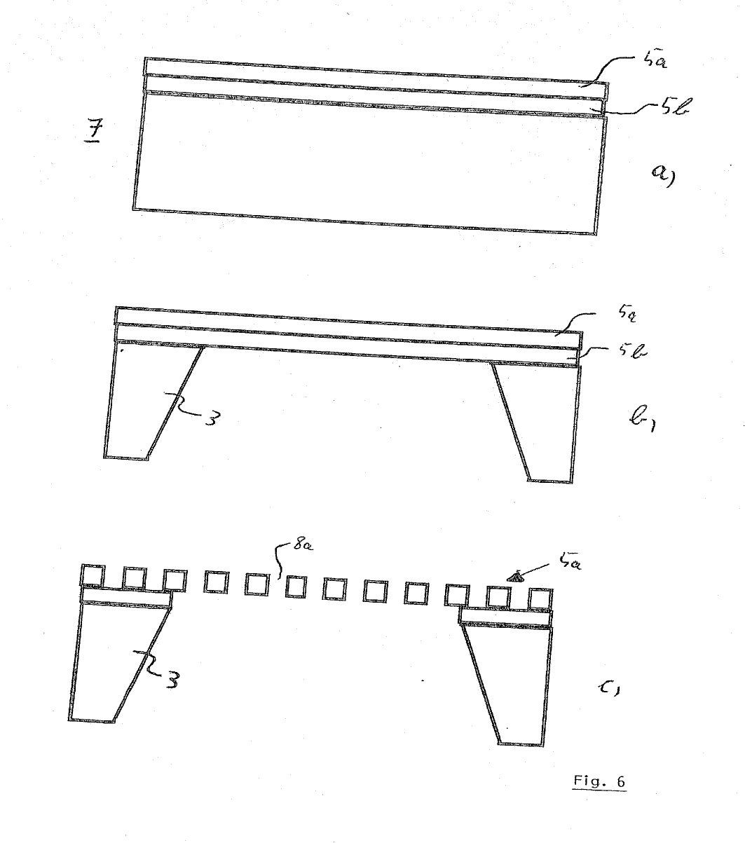

Another possible embodiment of the method according to the invention is now next described with reference to FIGS. 6a-c.

With this method the membrane can be produced with an even more exactly defined thickness. An SOI (silicon on insulator) wafer is used thereby. The thickness of the later membrane is thus already exactly established at the beginning through the thickness of the uppermost layer 5a (see FIG. 6a).

Now the etching of the substrate 7 is carried out from the rear thereof. The insulator layer 5b of the SOI wafer thereby serves as an etching stop. In this manner the carrier 3 for the later bridge-like membrane structure is produced from the substrate 7 (see FIG. 6b).

Now the removal of the area of the insulator layer 5b exposed from below is carried out by etching. Finally, the through holes 8a are produced in the top layer 5a of the SOI wafer, which is now embodied as a thin membrane, which is carried out in the present case through electrochemical etching (FIG. 6c). Particular areas of application for the micromechanical filter according to the invention are, for example, drinking water analysis, the analysis of other liquid media, such as, e.g., blood, the filtering and analysis of air, the detection and filtering of pathogens, warfare agents, and the like.

1-18. (canceled)

19. A micromechanical filter for microparticles, including pathogenic bacteria and viruses, said filter comprising:
a substrate;
a perforated membrane permanently connected to the substrate, for filtering out microparticles from a medium while flowing through the membrane;
a device for removing the filtered-out microparticles from the surface of the membrane.

20. A micromechanical filter according to claim 19, wherein:
the device for removing the filtered-out microparticles comprises a heating device for heating the membrane to burn the microparticles located on the surface of the membrane.

21. A micromechanical filter according to claim 20, wherein:
the heating device comprises electrical contacts structured and arranged to create a flow of heat current upon connection of a power source to said contacts.

22. A micromechanical filter according to claim 20, wherein:
the heating device comprises a serpentine heating element thermally coupled to the membrane.

23. A micromechanical filter according to claim 19, wherein:
the device for removing the microparticles comprises an actuator structure attached to the membrane to deform the membrane.

24. A micromechanical filter according to claim 23, wherein:
the actuator structure is structured and arranged to generate wave motions in the membrane.

25. A micromechanical filter according to claim 23, wherein:
the actuator structure is structured and arranged to generate wave motions in the membrane, in the form of surface waves.

26. A micromechanical filter according to claim 23, wherein:
the actuator structure is comprises at least one FPW structure.

27. A micromechanical filter according to claim 19, wherein:
the device for removing the microparticles comprises a micropump and/or a microinjector, structured and arranged to generate a flow parallel to a surface of the membrane, said flow detaching the microparticles from the membrane.

28. A micromechanical filter according to claim 19, further comprising:
a device structured and arranged to amplify bacteria that have been removed from a surface of the membrane.

29. A micromechanical filter according to claim 19, further comprising:
a detector unit for detecting the microparticles removed from the surface of the membrane.

30. A micromechanical filter according to claim 19, wherein:
the membrane is formed from monocrystalline silicon.

31. A micromechanical filter according to claim 19, wherein:
the membrane and the substrate are formed from monocrystalline silicon.

32. A micromechanical filter according to claim 19, wherein:
the membrane is formed from silicon carbide.

33. A micromechanical filter according to claim 19, wherein:
the membrane and the substrate are formed from silicon carbide.

34. A micromechanical filter according to claim 19, wherein:
the filter is produced from metal having an oxidation-resistant coating.

35. A method for producing a micromechanical filter, said method comprising:
porsifying a part of a substrate to form a layer with holes;
removing another part of the substrate to form a membrane from the substrate, wherein the membrane is formed from the layer provided with holes;
providing a device for removing deposits from a surface of the membrane.

36. A method according to claim 35, wherein:
first the porosifying of the substrate is carried out from a surface of the substrate up to a defined depth;
after said porosifying, the removing of another part of the substrate is carried out from an underside of the substrate, so that the layer provided with holes forms a membrane having through holes.

37. A method according to claim 35, wherein:
the substrate comprises a lower substrate layer with a silicon-on-insulator wafer arranged above the lower substrate layer; and
the method further comprises removing a part of the lower substrate layer by etching, the insulating layer of the silicon-on-insulator wafer being used as an etching stop.

38. A method according to claim 37, wherein:
after the etching of the lower substrate layer, the method comprises removing the insulation layer of the silicon-on-insulator wafer and, subsequently, porosifying the silicon layer of the silicon-on-insulator wafer is to form the membrane provided with through holes.

39. A method according to claim 35, for producing a micromechanical filter for microparticles, including pathogenic bacteria and viruses, said filter comprising:
a substrate;
a perforated membrane permanently connected to the substrate, for filtering out microparticles from a medium while flowing through the membrane;
a device for removing the filtered-out microparticles from the surface of the membrane.
